(19) United States
(12) Patent Application Publication
(10) Pub. No.: US 2019/0107755 A1
(43) Pub. Date: Apr. 11, 2019

(54) DISPLAY DEVICE

(71) Applicant: InnoLux Corporation, Miao-Li County (TW)

(72) Inventor: Chi-Wei CHEN, Miao-Li County (TW)

(21) Appl. No.: 16/115,618

(22) Filed: Aug. 29, 2018

(30) Foreign Application Priority Data
Oct. 10, 2017 (CN) 201710936596.X

(51) Int. Cl. G02F 1/1335; F21V 8/00; B29C 65/48

(52) U.S. Cl. CPC G02F 1/133606; G02F 1/133617; G02F 2201/086; B29C 65/4845; G02B 6/0026

(57) ABSTRACT

The present disclosure provides a display device, which includes: a display panel; and an optical film disposed at a side of the display panel, wherein the optical film includes: a supporting layer; and a first anti-UV layer disposed corresponding to the supporting layer, wherein the first anti-UV layer is an adhesive layer, a surface-treated layer, or an optical functional layer.

### CROSS REFERENCE TO RELATED APPLICATION

This application claims the benefits of the Chinese Patent Application Serial Number 201710936596.X, filed on Oct. 10, 2017, the subject matter of which is incorporated herein by reference.

### BACKGROUND

### 1. Field

The present disclosure relates to a display device. More particularly, the present disclosure relates to a display device with an optical film having anti-UV function.

### 2. Description of Related Art

With the continuous advancement of technologies related to displays, all the display panels are now developed toward compactness, thinness, and lightness. This trend makes thin displays, such as liquid crystal display panels, replace cathode-ray-tube displays as the mainstream display devices on the market. Applications of thin displays are numerous. Most electronic products for daily use, such as mobile phones, notebook computers, video cameras, still cameras, music displays, mobile navigators, and TV sets, employ such display panels.

However, the external UV light or the UV light from the backlight module causes adverse effect to the display device. For example, in the liquid crystal display device, the liquid crystal molecules or the polarizer may be damaged by the UV light, which influences the alignment of the liquid crystal molecules. In addition, the transistors in the display panel may also be damaged by the UV light, resulting in the switch property thereof deteriorated.

Therefore, it is desirable to provide an optical film with anti-UV function, so the influence of the UV light on the display device which may cause the display quality of the display device decreased can be prevented.

### SUMMARY

The present disclosure provides a display device, which comprises: a display panel; and an optical film disposed at a side of the display panel.

The optical film of the present disclosure comprises: a supporting layer; and a first anti-UV layer disposed corresponding to the supporting layer, wherein the first anti-UV layer is an adhesive layer, a surface-treated layer, or an optical functional layer.

In the present disclosure, the optical film itself comprises a first anti-UV layer. When the optical film is applied on a display device, UV light from external environment or the backlight module can be blocked or absorbed, and the display quality of the display device can further be improved.

Other novel features of the disclosure will become more apparent from the following detailed description when taken in conjunction with the accompanying drawings.

### BRIEF DESCRIPTION OF THE DRAWINGS

FIG. 1 is a cross-sectional view of an optical film according to one embodiment of the present disclosure.

FIG. 2 is a cross-sectional view of an optical film according to another embodiment of the present disclosure.

FIG. 3 is a cross-sectional view showing that an optical film is used as a polarizer according to one embodiment of the present disclosure.

FIG. 4 is a cross-sectional view showing that an optical film is used as a polarizer according to another embodiment of the present disclosure.

FIG. 5 is a cross-sectional view showing that an optical film is used as a polarizer according to further another embodiment of the present disclosure.

FIG. 6 is a cross-sectional view showing that an optical film is used as a polarizer according to further another embodiment of the present disclosure.

FIG. 7 is a cross-sectional view of a display device according to one embodiment of the present disclosure.

FIG. 8 is a cross-sectional view of a direct type backlight module according to one embodiment of the present disclosure.

FIG. 9 is a cross-sectional view of an edge type backlight module according to another embodiment of the present disclosure.

FIG. 10 is a diagram showing a relation between the transmittance and the wavelengths in an experimental example and a comparative example of the present disclosure.

### DETAILED DESCRIPTION OF EMBODIMENT

The following embodiments when read with the accompanying drawings are made to clearly exhibit the above-mentioned and other technical contents, features and/or effects of the present disclosure. Through the exposition by means of the specific embodiments, people would further understand the technical means and effects the present disclosure adopts to achieve the above-indicated objectives. Moreover, as the contents disclosed herein should be readily understood and can be implemented by a person skilled in the art, all equivalent changes or modifications which do not depart from the concept of the present disclosure should be encompassed by the appended claims.

Furthermore, the ordinals recited in the specification and the claims such as “first”, “second” and so on are intended only to describe the elements claimed and imply or represent neither that the claimed elements have any proceeding ordinals, nor that sequence between one claimed element and another claimed element or between steps of a manufacturing method. The use of these ordinals is merely to differentiate one claimed element having a certain designation from another claimed element having the same designation.

Furthermore, the terms recited in the specification and the claims such as “above”, “over”, or “on” are intended not only directly contact with the other element, but also intended indirectly contact with the other element. Similarly, the terms recited in the specification and the claims such as “below”, or “under” are intended not only directly contact with the other element but also intended indirectly contact with the other element.

Furthermore, the terms recited in the specification and the claims such as “connect” is intended not only directly connect with other element, but also intended indirectly connect and electrically connect with other element.

In addition, the features in different embodiments of the present disclosure can be mixed to form another embodiment.

FIG. 1 is a cross-sectional view of an optical film according to one embodiment of the present disclosure. In the process for preparing the optical film of the present embodiment, a supporting layer 11 is provided, followed by coating the supporting layer 11 with a matrix containing a light stabilizer dispersed therein. After a curing process, a first anti-UV layer 12 is formed on the supporting layer 11. Hence, an optical film of the present embodiment is obtained, which comprises: a supporting layer 11; and a first anti-UV layer 12 disposed corresponding to the supporting layer 11. In the present embodiment, the first anti-UV layer 12 is disposed on the supporting layer 11 and directly contacts the supporting layer 11. However, the present disclosure is not limited thereto. The first anti-UV layer 12 can be disposed on the supporting layer 11 but does not directly contact the supporting layer 11, and other film(s) may be selectively disposed between the first anti-UV layer 12 and the supporting layer 11.

Herein, the function of the optical film is not particularly limited. The optical film can be used as a brightness enhancement film, a light guide plate, a diffusion film, a polarizer, or any other film contained in a display device, as long as the optical film in the display device which has to have anti-UV effect can be the optical film of the present embodiment.

In the present embodiment, the first anti-UV layer 12 can be an adhesive layer, a surface-treated layer, or an optical functional layer. When the first anti-UV layer 12 is a surface-treated layer, the surface-treated layer can have at least one function of scratch resistance, anti-glare, anti-reflection or dirt resistance, or the surface-treated layer can make the optical film have a matt or glossy appearance. However, the present disclosure is not limited thereto. When the first anti-UV layer 12 is an optical functional layer, the optical functional layer can be a quantum dot enhancement layer, a phosphor film, or an optical film capable of blocking or absorbing light with any wavelength corresponding to one of an UVA band (which has a wavelength in a range from 315 nm to 400 nm), an UVB band (which has a wavelength in a range from 280 nm to 315 nm) and an UVC band (which has a wavelength in a range from 100 nm to 280 nm) or converting them into visible band. However, the present disclosure is not limited thereto.

In the present disclosure, the material comprised in the first anti-UV layer 12 is not particularly limited, as long as the first anti-UV layer 12 can at least absorb or block light with any wavelength corresponding to one of the UVA band, the UVB band and the UVC band. The UV transmittance of the first anti-UV layer 12 can be equal to or less than 50% in any wavelength corresponding to one of the UVA band, the UVB band and the UVC band. In another embodiment of the present disclosure, an average UV transmittance of the first anti-UV layer 12 can be equal to or less than 50% in one of the UVA band, the UVB band and the UVC band. In another embodiment of the present disclosure, the UV transmittance of the first anti-UV layer 12 can be greater than or equal to 5% and less than or equal to 25% (5%≤UV transmittance≤25%) in any wavelength corresponding to one of the UVA band, the UVB band and the UVC band. In further another embodiment of the present disclosure, the average UV transmittance of the first anti-UV layer 12 can be greater than or equal to 5% and less than or equal to 25% (5%≤average UV transmittance≤25%) in one of the INA band, the UVB band and the UVC band. In addition, the types of the first anti-UV layer 12 is not particularly limited, and can be, for example, an UV absorbing layer, an UV blocking layer, an UV converting layer, a free-radical scavenging layer, or a combination thereof.

When a proper amount of the light stabilizer is contained in the matrix for the first anti-UV layer 12, the aforesaid purpose of blocking or absorbing UVA, UVB or UVC can be achieved. Herein, the matrix for the first anti-UV layer 12 can comprise, for example, pressure sensitive adhesive, other adhesive materials, polymers or resins; but the present disclosure is not limited thereto.

In addition, the light stabilizer suitable for the first anti-UV layer 12 can be selected according to the desired property of the first anti-UV layer 12. When the first anti-UV layer 12 is an UV absorbing layer, the light stabilizer contained therein can be UV absorbers, which can absorb UV light effectively and only absorb small amount of visible light. Examples of the UV absorbers may comprise, but are not limited to, benzophenone, o-hydrobenzophenone, benzotriazole, salicylate, triazine, substituted acrylonitrile, oxalamide, or their derivatives. When the first anti-UV layer 12 is an UV blocking layer, the light stabilizer contained therein can be UV blocking agents, which can effectively absorb or reflect UV light. Thus, the UV light does not pass through the first anti-UV layer 12 to achieve the protection purpose against the UV light. Examples of the UV blocking agents may comprise, but are not limited to, organic additives or inorganic additives such as titanium dioxide. When the first anti-UV layer 12 is an UV converting layer, the light stabilizer contained therein can be UV quenching agents, which can convert the UV light into other energy to achieve the protection purpose against the UV light. Examples of the UV quenching agents may comprise, but are not limited to, organic nickel compounds. When the first anti-UV layer 12 is a free-radical scavenging layer, the light stabilizer contained therein can be free-radical scavenging agents, which can scavenge free radicals generated by the UV light in the matrix to achieve the protection purpose against the UV light. Examples of the free-radical scavenging agents may comprise, but are not limited to, hindered amine light stabilizers (HALS). When preparing the first anti-UV layer 12, one or more aforesaid light stabilizer can be added into the matrix to achieve the protection purpose against the UV light.

In one embodiment of the present disclosure, when the matrix for the first anti-UV layer 12 comprises polyester such as polymethylmethacrylate (PMMA), polyethylene terephthalate (PET) or a combination thereof, the light stabilizer suitable for the first anti-UV layer 12 may comprise, for example, a reactive product of o-nitroaniline and p-cresol, 2-hydroxy-4-methoxybenzophenone, hexamethylphosphoramide, 2-(2′-hydroxy-3′, 5′-ditertbutylphenyl)-5-chlorobenzotriazole, 2-(2′-hydroxy-3′, 5′-dipentylphenyl)-5-chlorobenzotriazole, 4-benzoyloxy-2, 2, 6, 6-tetramethylpiperidine, or a combination thereof; but the present disclosure is not limited thereto.

In addition, the supporting layer 11 can be a substrate or a film. The supporting layer 11 may comprise, for example, glass, plastic (such as PET, PMMA, polyimide (PI), triacetate cellulose (TAG) or other polymers), or resins; but the present disclosure is not limited thereto. Herein, the material for the supporting layer 11 may be a material without anti-UV property. Hence, an optical film with anti-UV property can be obtained by disposing the first anti-UV layer 12 on the supporting layer 11. Therefore, even though a substrate or a film with anti-UV property is not used as the supporting layer 11, an optical film with anti-UV property can be obtained by disposing the first anti-UV layer 12 on the supporting layer 11. Alternatively, when the supporting layer 11 containing a material with anti-UV property is co-used with the first anti-UV layer 12 with anti-UV property, the anti-UV property of the optical film can further be improved.

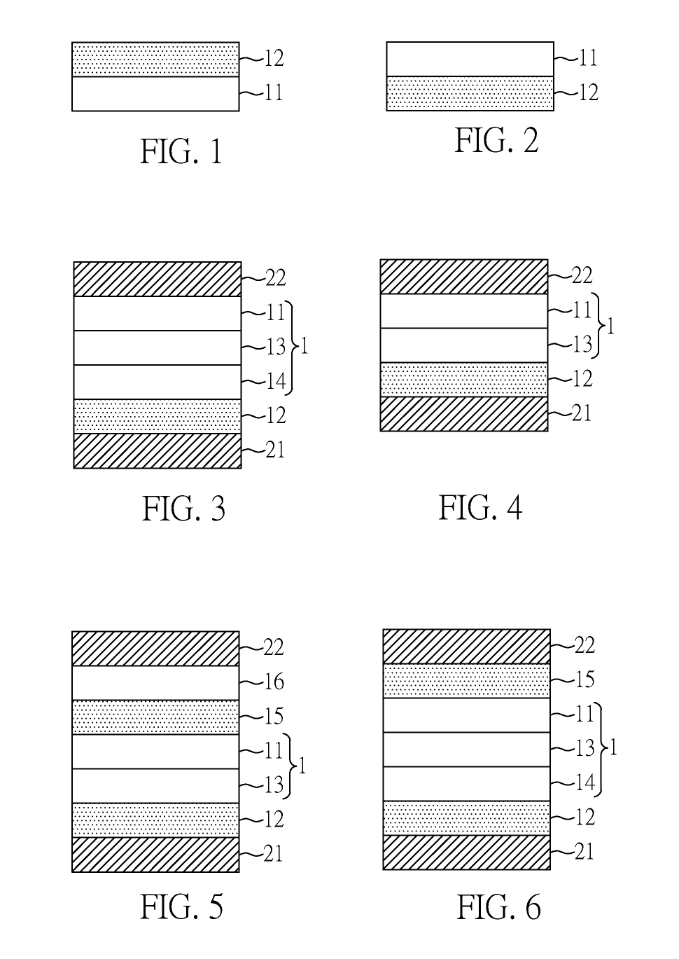

FIG. 2 is a cross-sectional view of an optical film according to another embodiment of the present disclosure. The material for and the structure of the optical film of the present embodiment are similar to those stated in the aforesaid embodiment. The difference is that the first anti-UV layer 12 is disposed under the supporting layer 11 and directly contacts the supporting layer 11. However, the present disclosure is not limited thereto. The first anti-UV layer 12 may be disposed under the supporting layer 11 but does not directly contact the supporting layer 11, and other film(s) may be selectively disposed between the first anti-UV layer 12 and the supporting layer 11.

When the optical film shown in FIG. 1 or FIG. 2 is used as a polarizer, the obtained polarizer may have a structure shown in any one of FIG. 3 to FIG. 5. However, FIG. 3 to FIG. 5 are only examples of possible polarizers, but the present disclosure is not limited thereto.

FIG. 3 is a cross-sectional view showing that an optical film is used as a polarizer according to one embodiment of the present disclosure. The optical film of the present embodiment comprises: a supporting layer 11; a first anti-UV layer 12 disposed corresponding to the supporting layer 11; and a polarizing layer 13 disposed between the supporting layer 11 and the first anti-UV layer 12, wherein the polarizing layer 13 comprises particles providing polarization. In addition, the optical film of the present embodiment may further comprise: a matrix layer 14 disposed between the polarizing layer 13 and the first anti-UV layer 12. Herein, the polarizer 1 of the present embodiment comprises the supporting layer 11, the polarizing layer 13 and the matrix layer 14, and the first anti-UV layer 12 is disposed under the polarizer 1. The first anti-UV layer 12 is an adhesive layer. In the present embodiment, the first anti-UV layer 12 is a pressure sensitive adhesive layer containing the aforesaid light stabilizer. In addition, a release film 21 and a protection film 22 are respectively disposed under the first anti-UV layer 12 and on the supporting layer 11. The release film 21 and the protection film 22 can provide temporary protection during the process for manufacturing the display device. When the polarizer 1 of the present embodiment is going to be adhered on a display panel, the release film 21 and the protection film 22 are removed, and the polarizer 1 can be adhered on the display panel via the first anti-UV layer 12.

Herein, the supporting layer 11 and the matrix layer 14 can protect the particles providing polarization without being damaged, and the material for the supporting layer 11 and the matrix layer 14 can be those stated above for the supporting layer. In the present embodiment, the supporting layer 11 and the matrix layer 14 may comprise PMMA or PET to improve the waterproof property of the polarizing layer 13 or maintain the extending, property of the polarizing layer 13. When the display device uses a polarizer in which the material for the supporting layer 11 or the matrix layer 14 comprises PMMA or PET, the environmental moisture or water resistance of the display device can be improved. Herein, the material for the supporting layer 11 and the matrix layer 14 can be a material without anti-UV property, so an optical film with anti-UV property can be obtained by using the first anti-UV layer 12 with anti-UV property.

FIG. 4 is a cross-sectional view showing that an optical film is used as a polarizer according to another embodiment of the present disclosure. The optical film of the present embodiment is similar to that shown in FIG. 3, except that the optical film of the present embodiment does not comprise the matrix layer 14 shown in FIG. 3.

FIG. 5 is a cross-sectional view showing that an optical film is used as a polarizer according to further another embodiment of the present disclosure. The optical film of the present embodiment is similar to that shown in FIG. 4, except for the following differences.

In the present embodiment, the optical film may further comprise a second anti-UV layer 15, and the supporting layer 11 is disposed between the first anti-UV layer 12 and the second anti-UV layer 15. An UV transmittance of the second anti-UV layer 15 is equal to or less than 50% in any wavelength corresponding to one of an UVA band, an UVB band and an UVC band. In another embodiment of the present disclosure, an average UV transmittance of the second anti-UV layer 15 is equal to or less than 50% in one of an UVA band, an UVB band and an UVC band. In another embodiment of the present disclosure, the UV transmittance of the second anti-UV layer 15 is greater than or equal to 5% and less than or equal to 25% (5%≤UV transmittance≤25%) in any wavelength corresponding to one of the UVA band, the UVB band and the UVC band. In further another embodiment of the present disclosure, the average UV transmittance of the second anti-UV layer 15 is greater than or equal to 5% and less than or equal to 25% (5%≤average UV transmittance≤25%) in one of the UVA band, the UVB band and the UVC band. Herein, the types and the properties of the second anti-UV layer 15 can be referred to those of the first anti-UV layer 12, and the descriptions thereof are not repeated again.

In addition, in the present embodiment, the optical film may further comprise a functional layer 16 disposed on the second anti-UV layer 15. The functional layer 16 can be a supporting layer comprising a surface-treated layer, wherein the surface-treated layer can have at least one function of scratch resistance, anti-glare, anti-reflection or dirt resistance, or the surface-treated layer can make the optical film have a matt or glossy appearance. Alternatively, the functional layer 16 can be an optical functional layer, wherein the optical functional layer can be a quantum dot enhancement layer, a phosphor film, or an optical film capable of blocking or absorbing light with any wavelength corresponding to one of an UVA band, an UVB band and an UVC band or converting them into visible band. However, the present disclosure is not limited thereto.

FIG. 6 is a cross-sectional view showing that an optical film is used as a polarizer according to further another embodiment of the present disclosure. The optical film of the present embodiment is similar to that shown in FIG. 3, except that the optical film of the present embodiment may further comprise a second anti-UV layer 15, and the supporting layer 11 is disposed between the first anti-UV layer 12 and the second anti-UV layer 15. Herein, the second anti-UV layer 15 can have the anti-UV function, and can also be used as a surface-treated layer. The types and the functions of the surface-treated layer are similar to those stated above, and the descriptions thereof are not repeated again.

It should be noted that, the structure obtained after removing the release film 21 and the protection film 22 shown in FIG. 3 to FIG. 6 is the optical film of the present disclosure.

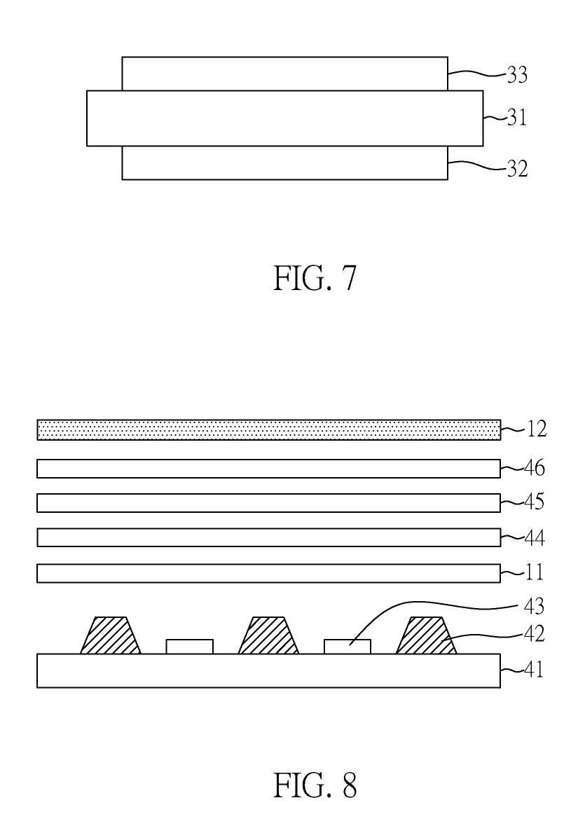

The optical film shown in FIG. 3 to FIG. 6 of the present disclosure can be adhered onto a display panel via the first anti-UV layer 12 after removing the release film 21 and the protection film 22 to obtain the display device shown in FIG. 7. The display device comprises: a display panel 31; a first optical film 32 disposed at a side of the display panel 31; and a second optical film 33 disposed at another side of the display panel 31, wherein the display panel 31 is disposed between the first optical film 32 and the second optical film 33. In the present embodiment, the first optical film 32 and the second optical film 33 can be identical or different according to the desired function. In addition, the first optical film 32 and the second optical film 33 can respectively be any one of the optical films shown in FIG. 3 to FIG. 6. Furthermore, the display panel 31 is a liquid crystal display panel.

Herein, the display panel 31 being a liquid crystal display panel is used as an example of the present disclosure. However, the present disclosure is not limited thereto. The optical film shown in FIG. 3 to FIG. 6 can be applied to various display devices, such as a display device including organic light-emitting diodes (OLEDs), quantum dots (QDs), fluorescence molecules, phosphors, light-emitting diodes (LEDs), mini light-emitting diodes (mini-LEDs), micro light-emitting diodes (micro-LEDs) or other display medium. The chip size of the LED can be 300 μm to 10 mm, the chip size of the mini-LED can be 100 μm to 300 μm, and the chip size of the micro-LED can be 1 μm to 100 μm. But the present disclosure is not limited thereto.

In addition, the application of the optical film of the present disclosure is not limited to the optical film used as a polarizer as shown in FIG. 3 to FIG. 6. The optical film of the present disclosure can be used in other units of the display device. For example, the optical film can be used as a light guide layer, a brightness enhancement layer, a diffusion layer or a light splitting layer in a backlight module, and light stabilizers can be selectively added therein to make the optical film as an UV absorbing layer, an UV blocking layer, an UV converting layer, a free-radical scavenging layer, or a combination thereof. However, the present disclosure is not limited thereto, and any optical functional layer in the backlight module can selectively comprise light stabilizers. Herein, the types and the properties of the light stabilizers are similar to those stated before, and the descriptions thereof are not repeated again.

FIG. 8 is a cross-sectional view of a direct type backlight module according to one embodiment of the present disclosure. The backlight module of the present embodiment comprises: a back board 41; at least one light source 43 disposed on the back board 41; plural light shieling units 42 disposed on the back board 41, wherein the light source 43 is disposed between two adjacent light shieling units 42; a supporting layer 11 disposed on the light source 43; a diffusion layer 44 disposed on the supporting layer 11; a light splitting layer 45 disposed on the diffusion layer 44; a phosphor film 46 disposed on the light splitting layer 45; and a first anti-UV layer 12 disposed on the phosphor film 46. Hence, the diffusion layer 44 is disposed between the supporting layer 11 and the first anti-UV layer 12, and the light splitting layer 45 is disposed between the diffusion layer 44 and the first anti-UV layer 12. The supporting layer 11 can be a brightness enhancement film, but the supporting layer 11 can be other films in other embodiment of the present disclosure. The light source 43 can be an UV light source, for example, a LED light source capable of emitting UV light. The phosphor film 46 can be a film comprising phosphors capable of converting UV light into visible light. When the first anti-UV layer 12 is disposed on the phosphor film 46, the first anti-UV layer 12 can absorb or block the UV light which is not covered into the visible light by the phosphor film 46.

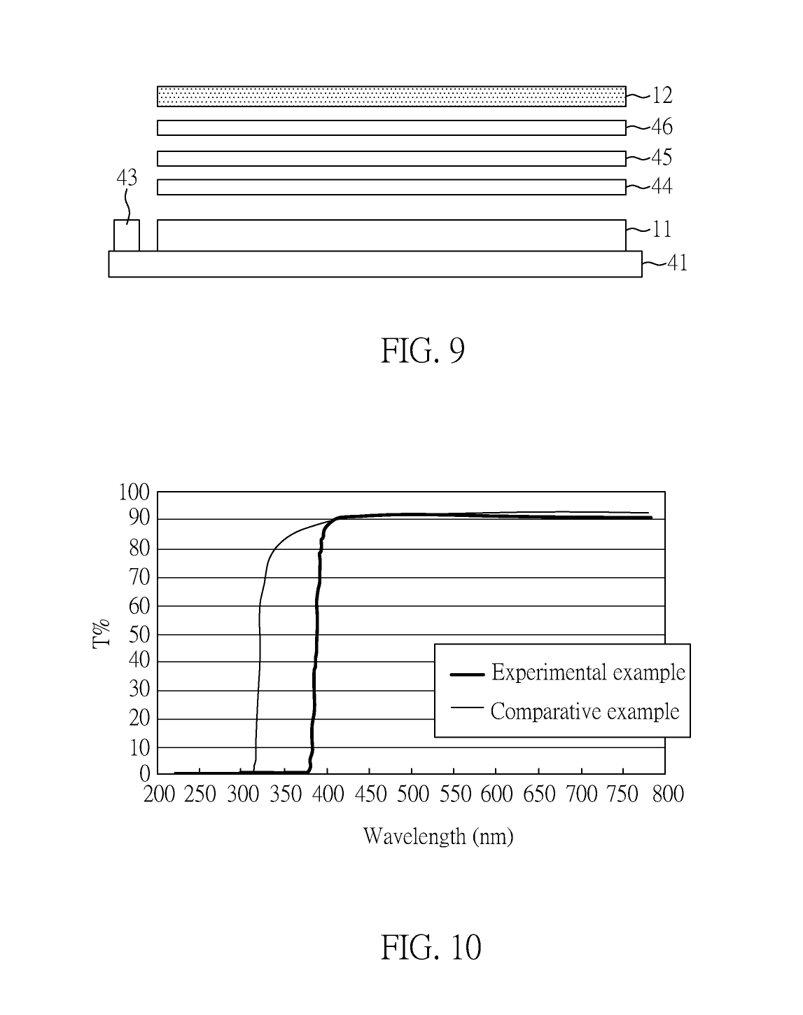

FIG. 9 is a cross-sectional view of an edge type backlight module according to another embodiment of the present disclosure. The backlight module of the present embodiment comprises: a back board 41; at least one light source 43 disposed on the back board 41; a supporting layer 11 disposed on the back board 41; a diffusion layer 44 disposed on the supporting layer 11; a light splitting layer 45 disposed on the diffusion layer 44; a phosphor film 46 disposed on the light splitting layer 45; and a first anti-UV layer 12 disposed on the phosphor film 46. The functions of the light source 43, the phosphor film 46 and the first anti-UV layer 12 are similar to those stated above, and the descriptions thereof are not repeated again.

The aforesaid direct type backlight module and edge type backlight module are only illustrated for examples, but the backlight module suitable for the display device of the present disclosure are not limited to have the structures shown in FIG. 8 and FIG. 9.

FIG. 10 is a diagram showing a relation between the transmittance and the wavelengths in an experimental example and a comparative example of the present disclosure. Herein, the optical film shown in FIG. 1 is used for the present test. The optical film used in the experimental example has the structure shown in FIG. 1, wherein the supporting layer 11 is a PET substrate, and the first anti-UV layer 12 is a pressure sensitive adhesive film comprising PMMA and added with o-phenyl hydroxybenzoate, a reactive product of o-nitroaniline and p-cresol, 2-hydroxy-4-methoxybenzophenone, hexamethylphosphoramide, 2-(2′-hydroxy-3′, 5′-ditertbutylphenyl)-5-chlorobenzotriazole, 2-(2′-hydroxy-3′, 5′-dipentylphenyl)-5-chlorobenzotriazole, 4-benzoyloxy-2, 2, 6, 6-tetramethylpiperidine, or a combination thereof. The optical film used in the comparative example is similar to that used in the experimental example, except that the first anti-UV layer 12 used in the comparative example is a pressure sensitive adhesive film comprising PMMA but without a light stabilizer. An UV-VIS spectrum analyzer is used to test the transmittance (T %) of the UV light. The result indicates that an average UV transmittance of the optical film of the experimental example is less than 50% in the UVA band. The result shows that the optical film of the experimental example can block most of the UV light having wavelength of 400 nm or less, but the optical film of the comparative example cannot block the UV light having wavelength of 400 nm or less. This result indicates that the optical film of the present disclosure can effectively block the UV light. In the present disclosure, the optical films disclosed in the aforesaid embodiments can be applied to any optical elements of the display device. In addition, a display device equipped with the optical film of the present disclosure can be co-used with a touch panel to form a touch display device. Meanwhile, a display device or a touch display device equipped with the optical film of the present disclosure can be a flexible or curved display device or touch display device. Furthermore, a display device or a touch display device may be applied to any electronic devices known in the art that need a display screen, such as displays, mobile phones, laptops, video cameras, still cameras, music players, mobile navigators, TV sets, and other electronic devices that display images.

Although the present disclosure has been explained in relation to its embodiment, it is to be understood that many other possible modifications and variations can be made without departing from the spirit and scope of the disclosure as hereinafter claimed.

What is claimed is:

1. A display device, comprising:
a display panel; and
an optical film disposed at a side of the display panel, wherein the optical film comprises:
a supporting layer; and
a first anti-UV layer disposed corresponding to the supporting layer,
wherein the first anti-UV layer is an adhesive layer, a surface-treated layer, or an optical functional layer.

2. The display device of claim 1, wherein the first anti-UV layer absorbs or blocks light with any wavelength corresponding to one of an UVA band, an UVB band and an UVC band.

3. The display device of claim 1, wherein an UV transmittance of the first anti-UV layer is equal to or less than 50% in any wavelength corresponding to one of an UVA band, an UVB band and an UVC band.

4. The display device of claim 1, wherein an average UV transmittance of the first anti-UV layer is equal to or less than 50% in one of an UVA band, an UVB band and an UVC band.

5. The display device of claim 1, wherein an UV transmittance of the first anti-UV layer is greater than or equal to 5% and less than or equal to 25% in any wavelength corresponding to one of an UVA band, an UVB band and an UVC band.

6. The display device of claim 1, wherein the first anti-UV layer is an UV absorbing layer, an UV blocking layer, an UV converting layer, a free-radical scavenging layer, or a combination thereof.

7. The display device of claim 1, wherein the supporting layer does not have anti-UV property.

8. The display device of claim 1, further comprising a polarizing layer disposed between the supporting layer and the first anti-UV layer.

9. The display device of claim 8, further comprising a second anti-UV layer, wherein the supporting layer is disposed between the first anti-UV layer and the second anti-UV layer.

10. The display device of claim 9, wherein an UV transmittance of the second anti-UV layer is equal to or less than 50% in any wavelength corresponding to one of an UVA band, an UVB band and an UVC band.

11. The display device of claim 9, wherein an average UV transmittance of the second anti-UV layer is equal to or less than 50% in one of an UVA band, an UVB band and an UVC band.

12. The display device of claim 9, wherein an UV transmittance of the second anti-UV layer is greater than or equal to 5% and less than or equal to 25% in any wavelength corresponding to one of an UVA band, an UVB band and an UVC band.

13. The display device of claim 9, wherein the second anti-UV layer is an UV absorbing layer, an UV blocking layer, an UV converting layer, a free-radical scavenging layer, or a combination thereof.

14. The display device of claim 9, wherein the second anti-UV layer comprise a matrix and a light stabilizer dispersed in the matrix, and the matrix comprises polymethylmethacrylate (PMMA), polyethylene terephthalate (PET) or a combination thereof.

15. The display device of claim 14, wherein the light stabilizer of the second anti-UV layer comprises an UV absorber, an UV blocking agent, an UV quenching agent, a free-radical scavenging agent or a combination thereof.

16. The display device of claim 1, wherein the supporting layer is a light guide plate.

17. The display device of claim 16, further comprising a diffusing layer disposed between the supporting layer and the first anti-UV layer.

18. The display device of claim 17, further comprising a light splitting layer disposed between the diffusing layer and the first anti-UV layer.

19. The display device of claim 1, wherein the first anti-UV layer comprise a matrix and a light stabilizer dispersed in the matrix, and the matrix comprises polymethylmethacrylate (PMMA), polyethylene terephthalate (PET) or a combination thereof.

20. The display device of claim 19, wherein the light stabilizer of the first anti-UV layer comprises an UV absorber, an UV blocking agent, an UV quenching agent, a free-radical scavenging agent or a combination thereof.
